(19) United States
(12) Patent Application Publication
(10) Pub. No.: US 2009/0046888 A1
(43) Pub. Date: Feb. 19, 2009

(54) Speaker

(76) Inventor: Chi En Huang, Taoyuan City (TW)

Correspondence Address: TROXELL LAW OFFICE PLLC, SUITE 1404, 5205 LEESBURG PIKE, FALLS CHURCH, VA, 22041, US

(21) Appl. No.: 11/889,548

(22) Filed: Aug. 14, 2007

(51) Int. Cl. H04R 1/00

(52) U.S. Cl. 381/398

(57) ABSTRACT

A speaker, which includes a bracket holding a magnetic loop assembly on the bottom side and a voice coil at the top of the magnetic loop assembly, a diaphragm covering the voice coil and having a stepped peripheral flange, and a suspension bonded between the stepped peripheral flange of the diaphragm and the bracket in a concentric manner relative to the diaphragm for linear reciprocating motion with the diaphragm to improve the output sound.

### BACKGROUND OF THE INVENTION

1. Field of the Invention

The present invention relates to speakers and more particularly, to an improved structure of speaker, which prohibits the suspension from a non-linear vibration during operation and assures harmonic reciprocating motion of the diaphragm and the suspension to provide a high-fidelity sound quality.

2. Description of the Related Art

Music is composed and performed for many purposes, ranging from aesthetic pleasure, religious or ceremonial purposes, or as an entertainment product for the marketplace. Listening to the music help you relax and reduce muscle tension as well as stress. Nowadays, consumers are critical to the sound quality of speakers. Except the quality of the main unit of an audio system, the speakers also determine the sound quality of the audio system.

The assembly design of a speaker has a great concern to its tone quality and tone color. Many new designs of speakers have been disclosed and have appeared on the market. Taiwan Patent No. 462574 discloses a speaker, which comprises a perforated iron member fastened to the bottom side of a bracket, a magnet mounted in the bracket within the perforated iron member, a ferrite washer provided at the top side of the magnet, a voice coil surrounding the ferrite washer, a first suspension bonded to a bonding portion at the periphery of the perforated iron member and the bottom side of the voice coil to hold the voice coil between the perforated iron member and the magnet, and a second suspension bonded to the top side of the voice coil. The suspensions limit the range of displacement of the voice coil. Therefore, the gap between the ferrite washer and the perforated iron member is minimized to improve the sensitivity of the speaker and reduce distortion of the speaker.

Actually, a single speaker is formed of a number of component parts including cone, magnetic loop assembly, coil, suspension, damper, and etc. The materials of these component parts and their alignment during installation affect the characteristic curve and quality of the speaker. After continuous improvement, conventional speaker fabrication technique has been gradually maturating. However, the alignment design of the arrangement between the suspension and the diaphragm in a conventional speaker, as shown in FIG. 1, is still not perfect because of the following disadvantages:
1. Either the suspension is arranged on the top side or bottom side of the diaphragm, the suspension may be deformed easily during compression bonding in the mold after application of a bonding glue, resulting in inaccurate concentricity.
2. To prevent an overflow of the bonding glue after bonding of the suspension to the top side of the diaphragm, the applied amount of the bonding glue must be reduced. However, reducing the applied amount of the bonding glue may result in a bonding defect, affecting the tone quality of the speaker.
3. To achieve high-fidelity tone quality, the diaphragm and the suspension must be reciprocated linearly during operation of the speaker. However, the insufficient structural strength of the diaphragm of a conventional speaker design may cause the diaphragm to deform when the diaphragm is stretched by the suspension during a piston action of the diaphragm, resulting disturbed sound.

### SUMMARY OF THE INVENTION

The present invention has been accomplished under the circumstances in view. It is therefore the main object of the present invention to provide a speaker, which prohibits the suspension from a non-linear vibration during operation, and assures harmonic reciprocating motion of the diaphragm and the suspension to provide a high-fidelity sound quality.

To achieve this and other objects of the present invention, the speaker comprises a bracket, which holds a magnetic loop assembly on its bottom side and a voice coil at the top of the magnetic loop assembly, a diaphragm, which covers the voice coil and has a stepped peripheral flange, and a suspension bonded between the stepped peripheral flange of the diaphragm and the bracket in a concentric manner relative to the diaphragm.

### BRIEF DESCRIPTION OF THE DRAWINGS

FIG. 1 is a schematic sectional plain view of a speaker according to the prior art.

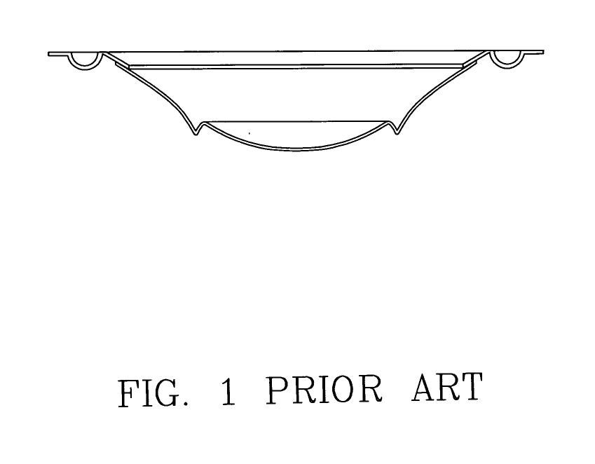

FIG. 2 is a schematic sectional plain view of a speaker in accordance with the present invention.

FIG. 3 is a schematic drawing of a part of the present invention, showing a bonding glue applied to the suspension and the diaphragm.

FIG. 4 is a schematic drawing showing the diaphragm and the suspension put in the mold for compression bonding according to the present invention.

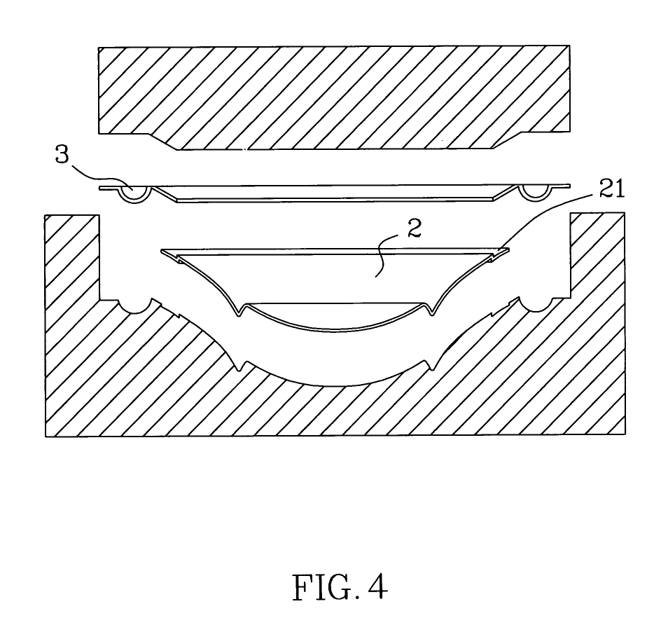

FIG. 5 is a schematic plain view of a part of the present invention, showing the diaphragm and the suspension bonded together.

FIG. 6 illustrates different configurations of diaphragms respectively used with different configurations of suspensions according to the present invention in which the stepped peripheral flange of each diaphragm curved downwards and then radially outwards and bonded to the bottom surface of the respective suspension.

FIG. 7 illustrates different configurations of diaphragms respectively used with different configurations of suspensions according to the present invention in which the stepped peripheral flange of each diaphragm curved upwards and then radially outwards and bonded to the top surface of the respective suspension.

### DETAILED DESCRIPTION OF THE PREFERRED EMBODIMENT

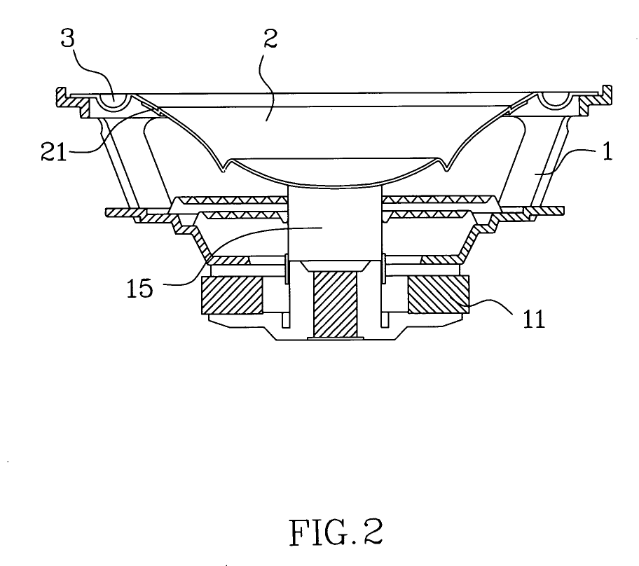

Referring to FIGS. 2˜7, a speaker in accordance with the present invention is shown comprising:

a bracket 1, which holds a magnetic loop assembly 11 on its bottom side and a voice coil 15 at the top side of the magnetic loop assembly 11;

a diaphragm 2, which covers the voice coil 15 and has a stepped peripheral flange 21; and

a suspension 3 bonded between the stepped peripheral flange 21 and the bracket 1.

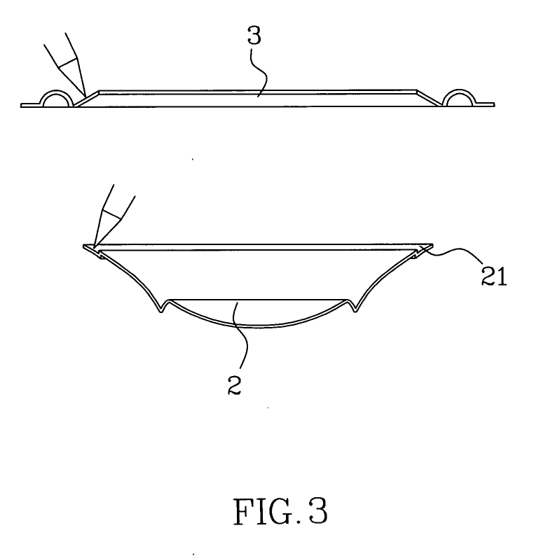

Referring to FIGS. 3˜5 again, the stepped peripheral flange 21 of the diaphragm 2 provides a gap that facilitates the application of a bonding glue to the suspension 3 and the diaphragm 2 during fabrication of the speaker. The design of the stepped peripheral flange 21 of the diaphragm 2 also facilitates the bonding of the suspension 3. When the suspension 3 is bonded to the diaphragm 2, the suspension 3 and the diaphragm 2 are accurately kept in a concentric manner. Because the bonding glue can conveniently be applied to the two sides, i.e., the suspension 3 and the diaphragm 2, the suspension 3 and the diaphragm 2 can be positively bonded together to maintain the nice outer looking. Therefore, the invention greatly improves the yield of the fabrication, and also greatly enhances the strength of the diaphragm 2.

Referring to FIG. 2 again, the stepped peripheral flange 21 of the diaphragm 2 guides the motion of the suspension 3 with the diaphragm 2. Therefore, the invention prohibits the suspension 3 from a non-linear vibration during operation of the speaker, and assures harmonic reciprocating motion of the diaphragm 2 and the suspension 3, providing a high-fidelity sound quality.

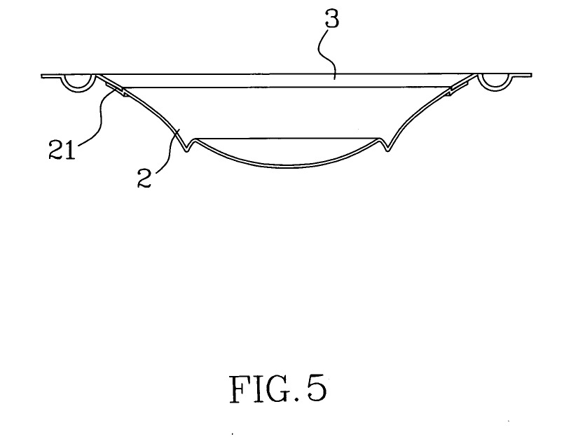

Referring to FIG. 5, the stepped peripheral flange 21 of the diaphragm 2 is curved downwards and then radially outwards, and bonded to the bottom surface of the suspension 3.

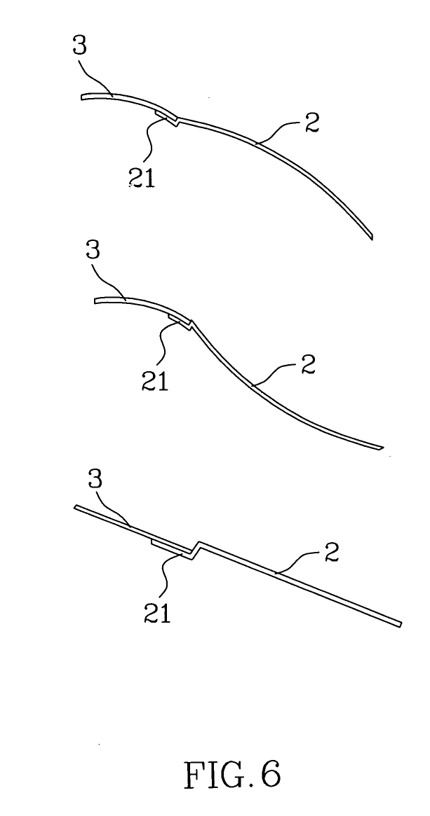

FIG. 6 illustrates different configurations of diaphragms 2 respectively used with different configurations of suspensions 3 according to the present invention.

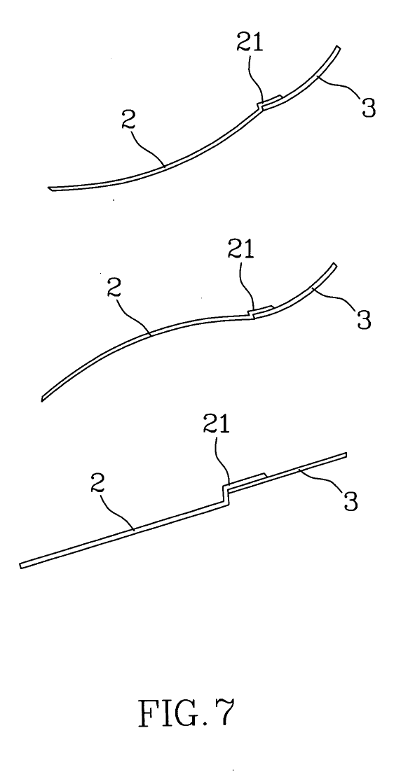

Referring FIG. 7, the stepped peripheral flange 21 of the diaphragm 2 can be curved upwards and then radially outwards, and bonded to the top surface of the suspension 3.

A prototype of speaker has been constructed with the features of FIGS. 2˜7. The speaker functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A speaker comprising
a bracket, said bracket holding a magnetic loop assembly on a bottom side thereof and a voice coil at a top side of said magnetic loop assembly;
a diaphragm covering said voice coil, said diaphragm having a stepped peripheral flange; and
a suspension bonded between the stepped peripheral flange of said diaphragm and said bracket in a concentric manner relative to said diaphragm.

2. The speaker as claimed in claim 1, wherein said stepped peripheral flange curved downwards and then radially outwards and bonded to a bottom surface of said suspension.

3. The speaker as claimed in claim 1, wherein said stepped peripheral flange curved upwards and then radially outwards and bonded to a top surface of said suspension.
